(19) United States
(12) Patent Application Publication
(10) Pub. No.: US 2023/0129000 A1
(43) Pub. Date: Apr. 27, 2023

(54) ELECTROCHEMICAL DEVICE

(71) Applicant: Panasonic Intellectual Property Management Co., Ltd., Osaka (JP)

(72) Inventors: NOBUTAKA TAKEDA, Osaka (JP); TAKUYA HIROBE, Kyoto (JP); RYOTA MORIOKA, Kyoto (JP); KENICHI NAGAMITSU, Kyoto (JP)

(21) Appl. No.: 17/905,645

(22) PCT Filed: Mar. 29, 2021
(86) PCT No.: PCT/JP2021/013179

§ 371 Date: Sep. 5, 2022

(30) Foreign Application Priority Data
Mar. 30, 2020 (JP) 2020-060947

(51) Int. Cl. H01M 4/60; H01M 4/137; H01M 50/102

(52) U.S. Cl. CPC H01M 4/602; H01M 4/137; H01M 50/102; H01M 2004/028

(57) ABSTRACT

Electrochemical device 200 disclosed includes positive electrode 10 and negative electrode 20. Positive electrode 10 includes a positive electrode material layer. The positive electrode material layer contains particles of an active material and a conductive agent. The cohesive force between the particles of the active material and the conductive agent is greater than the cohesive force between the conductive agent.

### TECHNICAL FIELD

The present disclosure relates to an electrochemical device.

### BACKGROUND

In recent years, an electrochemical device that has performance intermediate between a lithium ion secondary battery and an electric double layer capacitor attracts attention. For example, a power storage device using polyaniline or the like as a positive electrode material has been proposed (for example, PTLs 1 and 2). In an electrochemical device using polyaniline or the like as a positive electrode material, charging and discharging can be performed by adsorption (doping) and desorption (dedoping) of anions.

### CITATION LIST

### Patent Literature

PTL 1: Unexamined Japanese Patent Publication No. 2014-099296
PTL 2: Unexamined Japanese Patent Publication No. 2014-110079

### SUMMARY

In an electrochemical device used as a power storage device, high capacitance and low resistance are required. An object of the present disclosure is to provide an electrochemical device capable of achieving high capacitance and low resistance.

One aspect of the present disclosure relates to an electrochemical device. The electrochemical device is an electrochemical device including a positive electrode and a negative electrode, in which the positive electrode includes a positive electrode material layer. The positive electrode material layer includes particles of an active material and a conductive agent. A cohesive force between the particles of the active material and the conductive agent is greater than a cohesive force between the conductive agent.

According to the present disclosure, an electrochemical device capable of achieving high capacitance and low resistance is obtained.

### BRIEF DESCRIPTION OF THE DRAWINGS

FIG. 1 is a sectional view schematically illustrating an example of an electrochemical device of the present disclosure.

### DESCRIPTION OF EMBODIMENT

Hereinafter, an exemplary embodiment of the present disclosure will be described with reference to examples, but the present disclosure is not limited to examples to be described below. In the following description, specific numerical values and materials may be exemplified, but other numerical values and materials may be applied as long as the effects of the present disclosure can be obtained. In this specification, the case of “a range from a numerical value A to a numerical value B” includes the numerical value A and the numerical value B.

Hereinafter, first and second electrochemical devices of the present disclosure will be described.

### (First Electrochemical Device)

The first electrochemical device of the present disclosure includes a positive electrode and a negative electrode. The positive electrode includes a positive electrode material layer. The positive electrode material layer contains particles of an active material and a conductive agent. The cohesive force between the particles of the active material and the conductive agent is greater than the cohesive force between the conductive agent. In the first electrochemical device, the conductive agent may be disposed on the surfaces of the particles of the active material. As described in Examples, the first electrochemical device can achieve high capacitance and low resistance.

The particles of the active material and the conductive agent used for the positive electrode of the first electrochemical device are substantially the same as particles of a conductive polymer and a conductive agent used for the positive electrode of the second electrochemical device, respectively, and thus overlapping description is omitted. Portions other than the positive electrode of the first electrochemical device are substantially the same as portions other than the positive electrode of the second electrochemical device, and thus overlapping description is omitted.

### (Second Electrochemical Device)

The second electrochemical device of the present disclosure includes a positive electrode and a negative electrode. The positive electrode includes a positive electrode material layer. The positive electrode material layer contains the particles of the conductive polymer, a dopant, and a particulate conductive agent. Hereinafter, the particles of the conductive polymer contained in the positive electrode material layer may be referred to as “conductive polymer (P)”. In addition, the particulate conductive agent contained in the positive electrode material layer may be hereinafter referred to as “conductive agent (C)”.

The second electrochemical device satisfies following configurations (1) to (3).

(1) The average particle size of conductive polymer (P) is in the range from 1 μm to 5 μm, inclusive.
(2) The average particle size of conductive agent (C) is in the range from 5 nm to 30 nm, inclusive.
(3) A DBP absorption amount of conductive agent (C) is in the range from 110 ml/100 g to 160 ml/100 g, inclusive.

In this specification, the average particle sizes of conductive polymer (P) and conductive agent (C) are each a median diameter (D₅₀) at which a cumulative volume is 50% in a volume-based particle size distribution. The median diameter is determined, for example, using a laser diffraction and scattering type particle size distribution measuring apparatus.

In this specification, the DBP absorption amount of conductive agent (C) is a value measured according to JIS K 6217-4 (2008).

It is effective to add a conductive agent to the positive electrode material layer in order to reduce internal resistance. Meanwhile, the particles of the conductive polymer have higher interface resistance than other materials such as activated carbon particles. Hence, when the particles of the conductive polymer are used as a material for charging and discharging in the positive electrode, the resistance is not sufficiently reduced simply by adding a conductive agent, unlike the case of using activated carbon particles or the like. In order to reduce the internal resistance when the particles of the conductive polymer are used, it is important to uniformly coat the surfaces of the particles of the conductive polymer with the conductive agent. Such a state can be realized by satisfying above-described configurations (1) to (3). Since the second electrochemical device satisfies configurations (1) to (3), it is possible to increase the capacitance and reduce the resistance as shown in Examples.

The conductive polymer constituting conductive polymer (P) may be at least one selected from polyaniline and a derivative thereof.

The first and second electrochemical devices may each include the positive electrode, the negative electrode, a separator, an electrolyte, and a case housing them. As the negative electrode, the separator, the electrolyte, and the case, a negative electrode, a separator, an electrolyte, and a case used in a lithium ion secondary battery may be used. Examples of the positive electrode, the negative electrode, the separator, and the electrolyte will be described below. The case is not particularly limited, and a case similar to a case used for a lithium ion secondary battery or a case used for an electric double layer capacitor may be used.

### (Positive Electrode)

The positive electrode of the second electrochemical device will be described below. The positive electrode may include a positive electrode core material, and the positive electrode material layer may be disposed on the positive electrode core material.

### (Positive Electrode Material Layer)

As the conductive polymer constituting conductive polymer (P) used for the positive electrode material layer, a π-conjugated polymer is preferably used. As the π-conjugated polymer, polypyrrole, polythiophene, polyfuran, polyaniline, polythiophene vinylene, polypyridine, and derivatives of these polymers can be used, for example. These may be used alone or in combination of two or more thereof. The weight-average molecular weight of the conductive polymer is not particularly limited and may be, for example, in the range from 1,000 to 100,000, inclusive.

Derivatives of polypyrrole, polythiophene, polyfuran, polyaniline, polythiophene vinylene, and polypyridine mean polymers having, as a basic skeleton, polypyrrole, polythiophene, polyfuran, polyaniline, polythiophene vinylene, and polypyridine, respectively.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). These may be used alone or may be used in combination of two or more kinds.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. These may be used alone or may be used in combination of two or more kinds.

As conductive agent (C), for example, a particulate conductive agent containing a conductive carbon material (for example, a particulate conductive agent constituted of a conductive carbon material) can be used. Examples of such a conductive agent include carbon black. Examples of carbon black include acetylene black, ketjen black, and furnace black. Furnace black is preferable in that materials having different DBP absorption amounts are easily available.

The content proportion of conductive polymer (P) in the positive electrode material layer may be in the range from 60 mass % to 90 mass %, inclusive. The content proportion of conductive agent (C) in the positive electrode material layer may be in the range from 1 mass % to 20 mass %, inclusive.

The thickness of the positive electrode material layer is not particularly limited and may be, for example, in the range from 10 μm to 300 μm, inclusive.

The positive electrode material layer may contain a substance other than conductive polymer (P) and conductive agent (C) as necessary. For example, the positive electrode material layer may contain a binder or the like. Examples of the binder include a fluorine resin, an acrylic resin, a rubber material, and a cellulose derivative. Examples of the fluorine resin include polyvinylidene fluoride, polytetrafluoroethylene, and a tetrafluoroethylene-hexafluoropropylene copolymer. Examples of the acrylic resin include polyacrylic acid and an acrylic acid-methacrylic acid copolymer. Examples of the rubber material include styrene-butadiene rubber. Examples of the cellulose derivative include carboxymethylcellulose.

The positive electrode material layer may be formed by applying a mixture (positive electrode mixture paste or dispersion liquid) containing materials constituting the positive electrode material layer and a dispersion medium to the positive electrode core material and then drying the mixture. The materials constituting the positive electrode material layer include conductive polymer (P) and conductive agent (C). As the dispersion medium, water, a non-aqueous solvent such as alcohol, and a mixed solution thereof may be used.

Alternatively, conductive polymer (P) in the positive electrode material layer may be formed by electrolytic polymerization. Conductive polymer (P) may be formed, for example, by immersing the positive electrode core material in a reaction solution containing a raw material monomer of the conductive polymer and electrolytically polymerizing the raw material monomer in the presence of the positive electrode core material. At this time, by performing electrolytic polymerization with the positive electrode core material as an anode, the positive electrode material layer containing the conductive polymer is formed so as to cover the positive electrode core material. The thickness of the positive electrode material layer can be controlled by the electrolytic current density, the polymerization time, and the like. Chemical polymerization may be used instead of electrolytic polymerization.

The raw material monomer used in electrolytic polymerization or chemical polymerization may be any polymerizable compound capable of producing a conductive polymer by polymerization. The raw material monomer may include an oligomer. Examples of the raw material monomer that can be used include aniline, pyrrole, thiophene, furan, thiophene vinylene, pyridine, and derivatives of these monomers. These materials may be used alone or in combination of two or more. Among them, aniline is likely to grow on the surface of a carbon layer by electrolytic polymerization.

Electrolytic polymerization or chemical polymerization may be carried out using a reaction solution containing anions (dopant). A π-electron conjugated polymer doped with a dopant exhibits excellent conductivity. For example, in chemical polymerization, the positive electrode core material may be immersed in a reaction solution containing a dopant, an oxidizing agent, and a raw material monomer, then withdrawn from the reaction solution, and dried. In electrolytic polymerization, the positive electrode core material and a counter electrode may be immersed in a reaction solution containing the dopant and the raw material monomer, and a current may be passed between them with the positive electrode core material as an anode.

### (Positive Electrode Core Material)

The positive electrode core material includes a positive current collector. For the positive current collector, for example, a sheet-shaped metallic material can be used. Examples of the sheet-shaped metallic material include a metal foil, a porous metal body, and an etched metal. As the metallic material, aluminum, aluminum alloy, nickel, titanium, or the like may be used. The thickness of the positive current collector may be, for example, in the range from 10 μm to 100 μm, inclusive.

The positive electrode core material may include a conductive layer (such as a carbon layer) formed on the positive current collector. The conductive layer can improve the current collecting property from the positive electrode material layer to the positive current collector. The carbon layer may be formed by depositing a conductive carbon material on the positive current collector. Alternatively, the carbon layer may be formed by forming a coating film of a paste containing a conductive carbon material on the positive current collector and then drying the coating film. The paste may include a conductive carbon material, a polymer material, and water or an organic solvent. The thickness of the carbon layer may be, for example, in the range from 1 μm to 20 μm, inclusive. Examples of the conductive carbon material include graphite, hard carbon, soft carbon, and carbon black. Carbon black may form a thin carbon layer having excellent conductivity. Examples of the polymer material include fluorine resin, acrylic resin, polyvinyl chloride, and styrene-butadiene rubber (SBR).

### (Negative Electrode)

The negative electrode includes a negative electrode material layer. The negative electrode may include a negative electrode core material, and the negative electrode material layer may be disposed on the negative electrode core material.

### (Negative Electrode Core Material)

A sheet-shaped metallic material is used as the negative electrode core material. The sheet-shaped metallic material may be a metal foil, a porous metal body, an etched metal, or the like. As the metallic material, copper, copper alloy, nickel, stainless steel, or the like may be used. The thickness of the negative electrode core material may be, for example, in the range from 10 μm to 100 μm, inclusive.

### (Negative Electrode Material Layer)

The negative electrode material layer preferably contains, as a negative electrode active material, a material that electrochemically stores and releases lithium ions. Examples of such a material include a carbon material, a metal compound, an alloy, and a ceramic material. As the carbon material, graphite, hardly-graphitizable carbon (hard carbon), and easily-graphitizable carbon (soft carbon) are preferable, and graphite and hard carbon are particularly preferable. Examples of the metal compound include silicon oxides and tin oxides. Examples of the alloy include silicon alloys and tin alloys. Examples of the ceramic material include lithium titanate and lithium manganate. These may be used alone or may be used in combination of two or more kinds. The carbon material is preferable from the viewpoint that the material is capable of lowering the potential of the negative electrode.

The negative electrode material layer may contain a conductive agent, a binder, and the like in addition to the negative electrode active material. Examples of the conductive agent include carbon black and carbon fiber. As the binder, the binder exemplified as the binder that can be used in the positive electrode material layer may be used.

The negative electrode material layer may be manufactured by a method similar to a method for manufacturing a negative electrode of a lithium ion secondary battery. The negative electrode material layer is formed by, for example, mixing the negative electrode active material, the conductive agent, the binder, and the like with a dispersion medium to prepare a negative electrode mixture paste, applying the negative electrode mixture paste to the negative current collector, and then drying the negative electrode mixture paste. The thickness of the negative electrode material layer may be, for example, in the range from 10 μm to 300 μm, inclusive.

The negative electrode is preferably pre-doped with lithium ions in advance. This decreases the potential of the negative electrode and thus increases a difference in potential (that is, voltage) between the positive electrode and the negative electrode and improves energy density of the electrochemical device.

In an example of pre-doping the negative electrode with lithium ions, first, a metal lithium film serving as a lithium ion supply source is formed on the surface of the negative electrode material layer. Next, the negative electrode on which the metal lithium film is formed is immersed in an electrolytic solution (such as a non-aqueous electrolytic solution) having lithium ion conductivity. As a result, pre-doping of the negative electrode with lithium ions proceeds. At this time, the lithium ions are eluted from the metal lithium film into the non-aqueous electrolytic solution, and the eluted lithium ions are stored in the negative electrode active material. For example, when graphite or hard carbon is used as the negative electrode active material, lithium ions are inserted in between layers of graphite or in fine pores of hard carbon. The amount of lithium ions for the pre-doping can be controlled by the mass of the metal lithium film. The amount of lithium ions for the pre-doping may be, for example, in the range from 50% to 95%, inclusive of the maximum amount of lithium ions that can be occluded in the negative electrode material layer.

The step of pre-doping the negative electrode with lithium ions may be performed before assembling an electrode group. Alternatively, the non-aqueous electrolytic solution and the electrode group may be housed in a container of the electrochemical device, and then pre-doping may be performed.

### (Separator)

As the separator, a woven fabric, a nonwoven fabric, a porous film, or the like made of an insulating material may be used. For example, as the separator, a nonwoven fabric made of cellulose fiber, a nonwoven fabric made of glass fiber, a microporous film made of polyolefin, a woven fabric, a nonwoven fabric, or the like may be used. The thickness of the separator may be, for example, in the range from 10 μm to 300 μm, inclusive (for example, from 10 μm to 40 μm, inclusive).

The separator is disposed between the positive electrode and the negative electrode. The positive electrode, the negative electrode, and the separator constitute an electrode body. The electrode body may be formed by winding the positive electrode, the negative electrode, and the separator. Alternatively, the electrode body may be formed by stacking the positive electrode, the negative electrode, and the separator.

### (Electrolyte)

The electrolyte has lithium ion conductivity, contains a lithium salt and a solvent that dissolves the lithium salt, and has lithium ion conductivity. Doping and dedoping of the positive electrode with the anions of the lithium salt may be reversibly repeated. Lithium ions derived from the lithium salt are reversibly absorbed in and released from the negative electrode. The electrolyte may be a non-aqueous electrolytic solution and may be a non-aqueous electrolytic solution used for a lithium ion secondary battery.

Examples of the lithium salt include LiClO₄, LiBF₄, LiPF₆, LiAlCl₄, Li SbF₆, LiSCN, LiCF₃SO₃, LiFSO₃, LiCF₃CO₂, LiAsF₆, LiBioCl₁₀, LiCl, LiBr, LiI, LiBCl₄, LiN(FSO₂)₂, and LiN(CF₃SO₂)₂. These lithium salts may be used alone or in combination of two or more lithium salts. Among them, a salt having a fluorine-containing anion is preferable. The concentration of the lithium salt in the non-aqueous electrolyte in the charged state (charging rate (SOC) of 90% to 100%) may be, for example, in the range from 0.2 mol/L to 5 mol/L, inclusive.

Examples of usable solvents include: cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propionitrile; nitromethane; ethylmonoglyme; trimethoxymethane; sulfolane; methylsulfolane; and 1,3-propane sultone. These materials may be used alone or in combination of two or more.

The electrolyte may contain various additive agents as needed. For example, the electrolyte may contain an unsaturated carbonate such as vinylene carbonate, vinylethylene carbonate, and divinylethylene carbonate. These additive agents form a coating film having lithium ion conductivity on the surface of the negative electrode.

In the first and second electrochemical devices, in the positive electrode, charging and discharging can be performed by doping and dedoping conductive polymer (P) with a dopant (such as anions). In addition, in the negative electrode, charging and discharging can be performed by occlusion and release of lithium ions.

Hereinafter, an example of the second electrochemical device of the present disclosure will be specifically described with reference to the drawing. The first electrochemical device of the present disclosure can also have the same configuration as the electrochemical device exemplified below. The above-described configuration elements can be applied to configuration elements of the electrochemical device to be described below. Further, constituent elements of the electrochemical device described below can be changed on the basis of the above description. Furthermore, the matters described above may be applied to the exemplary embodiment described below. In addition, in the exemplary embodiment described below, configuration elements that are not essential to the electrochemical device of the present disclosure may be omitted.

### First Exemplary Embodiment

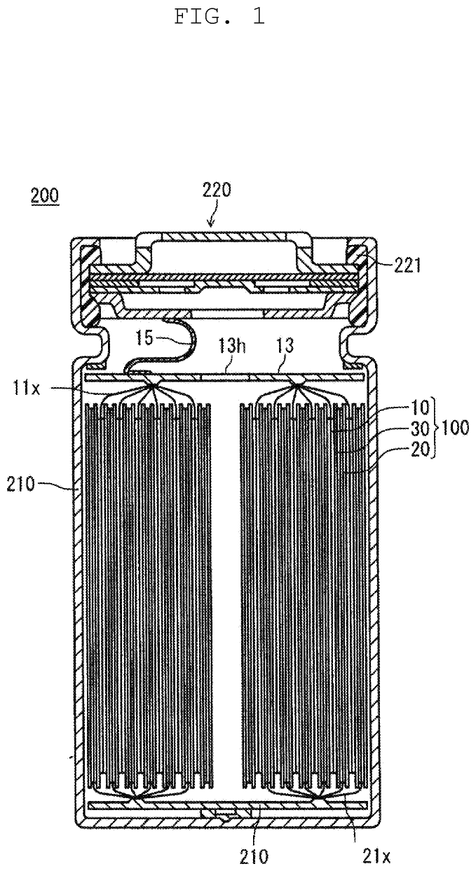

FIG. 1 is a schematic cross-sectional view illustrating electrochemical device 200 of a first exemplary embodiment, which is an example of the second electrochemical device. In FIG. 1, hatching of some members is omitted.

Electrochemical device 200 is provided with electrode body 100, a non-aqueous electrolytic solution (not shown), metallic bottomed cell case (container) 210 housing electrode body 100 and the non-aqueous electrolytic solution, sealing body 220 sealing an opening of cell case 210, and gasket 221.

Electrode body 100 is configured as a columnar wound body by, for example, winding belt-shaped positive electrode 10 and belt-shaped negative electrode 20 together with separator 30 interposed between them. Electrode body 100 may also be formed as a stacked body in which a plate-like positive electrode and a plate-like negative electrode are stacked with a separator interposed between them. Positive electrode 10 includes a positive electrode core material and a positive electrode material layer supported by the positive electrode core material. Negative electrode 20 includes a negative electrode core material and a negative electrode material layer supported by the negative electrode core material.

Gasket 221 is disposed on the peripheral edge of sealing body 220. The open end of cell case 210 is caulked by gasket 221, whereby the inside of cell case 210 is sealed. Positive electrode current collecting plate 13 having through hole 13h in the center is welded to positive-electrode-core-material exposed part 11x. One end of tab lead 15 is connected to positive electrode current collecting plate 13, and the other end is connected to sealing body 220. Thus, sealing body 220 has a function as a positive electrode terminal. On the other hand, negative electrode current collecting plate 23 is welded to negative-electrode-core-material exposed part 21x. Negative electrode current collecting plate 23 is welded to a welding member disposed on the bottom surface of cell case 210. Thus, cell case 210 has a function as a negative electrode terminal.

### (Manufacturing Method)

Hereinafter, an example of a method of manufacturing electrochemical device 200 will be described. The method for manufacturing the electrochemical device of the present disclosure, however, is not limited to the example described below.

First, positive electrode 10 and negative electrode 20 are produced by the method described above. Next, positive electrode 10, negative electrode 20, and separator 30 are wound together to form electrode body 100. Next, positive-electrode-core-material exposed part 11x of positive electrode 10 is connected to positive electrode current collecting plate 13. Negative-electrode-core-material exposed part 21x of negative electrode 20 is welded to negative electrode current collecting plate 23.

Next, electrode body 100 is housed in cell case 210 together with the non-aqueous electrolytic solution (not shown). Before the non-aqueous electrolytic solution is housed in cell case 210, positive electrode current collecting plate 13 and sealing body 220 are connected to each other by tab lead 15, and negative electrode current collecting plate 23 and cell case 210 are connected to each other. Next, sealing body 220 is disposed in the opening of cell case 210 to seal cell case 210. Specifically, the vicinity of the opening end of cell case 210 is drawn inward. In this way, electrochemical device 200 is obtained. As described above, pre-doping is performed at an appropriate stage as necessary.

In the above exemplary embodiment, the wound electrochemical device having a cylindrical shape has been described, but the electrochemical device of the present disclosure may be an electrochemical device in another form. For example, the electrochemical device of the present disclosure can also be applied to a wound electrical device having a rectangular shape or a stacked electrochemical device.

### EXAMPLES

Hereinafter, examples of the electrochemical device of the present disclosure will be described in more detail with reference to Examples.

### Example 1

In Example 1, the first and second electrochemical devices were produced and evaluated. In the production of the following devices, commercially available products were used as conductive polymer (P) having different average particle sizes and conductive agent (C) having different average particle sizes and different DBP absorption amounts.

### (Electrochemical Device A1)

Electrochemical device A1 was produced by the following method.

### (1) Production of Positive Electrode

A positive electrode core material was produced by sequentially forming an aluminum carbide layer (thickness: 100 nm, mass ratio of carbon atoms: 25 mass %) and a carbon layer containing carbon black (thickness: 2 μm) on both surfaces of an aluminum foil having a thickness of 30 μm.

In addition, a mixture (positive electrode slurry) containing a material constituting the positive electrode material layer and a dispersion medium was prepared. As conductive polymer (P), polyaniline particles having an average particle size (D₅₀) of 3 μm were used. Carbon black was used as conductive agent (C). As carbon black, carbon black having an average particle size (D₅₀) of 5 nm and a DBP absorption amount of 160 ml/100 g was used. The mixture was prepared by mixing conductive polymer (P), a dispersion liquid of conductive agent (C), a dispersion liquid of carboxymethyl cellulose (CMC), and a dispersion liquid of styrene-butadiene rubber (SBR) at a mass ratio of 100:17.5:3.0:10. The dispersion liquid of conductive agent (C) was constituted of conductive agent (C) and water with a mass ratio of conductive agent (C):water=20:80. The dispersion liquid of CMC was constituted of CMC and water with a mass ratio of CMC:water=5:95. The dispersion liquid of SBR was constituted of SBR and water with a mass ratio of SBR:water=40:60.

Next, the mixture (positive electrode slurry) was applied to both surfaces of the positive electrode core material with a bar coater to form a coating film. Next, the core material on which the coating film was formed was heated to about 60° C. to 90° C. on a hot plate and further vacuum-dried at 110° C. for 12 hours. In this way, a positive electrode was produced.

### (2) Production of Negative Electrode

A copper foil having a thickness of 20 μm was prepared as a negative current collector. In addition, a negative electrode mixture paste was prepared by kneading a mixed powder containing 97 parts by mass of hard carbon, 1 part by mass of carboxycellulose, and 2 parts by mass of styrene-butadiene rubber with water at a mass ratio of 40:60. Next, the negative electrode mixture paste was applied to both surfaces of the negative current collector and dried. In this way, a negative electrode having a negative electrode material layer having a thickness of 35 μm on both surfaces was obtained. Next, pre-doping with metal lithium was performed. The amount of the metal lithium was an amount calculated so that the negative electrode that had been pre-doped and was in an electrolytic solution had a potential of less than or equal to 0.2 V with respect to a potential of metal lithium.

### (3) Production of Electrode Group

Lead tabs were respectively connected to the positive electrode and the negative electrode, and then a stacked body in which a nonwoven fabric separator (thickness 35 μm) made of cellulose, the positive electrode, and the negative electrode are alternately stacked on each other was wound to form an electrode group.

### (4) Preparation of Non-Aqueous Electrolytic Solution

A solvent was prepared by adding 0.2 mass % of vinylene carbonate to a mixture of propylene carbonate and dimethyl carbonate in a volume ratio of 1:1. LiPF₆ was dissolved as a lithium salt in the obtained solvent at a predetermined concentration to prepare a non-aqueous electrolytic solution containing hexafluorophosphate ions (PF₆⁻) as the anions.

### (5) Production of Electrochemical Device

The electrode group and the non-aqueous electrolytic solution were put into a bottomed container having an opening to assemble an electrochemical device as shown in FIG. 1. Thereafter, aging was performed by applying a charge voltage of 3.8 V between terminals of the positive electrode and the negative electrode at 25° C. for 24 hours to progress pre-doping of the negative electrode with lithium ions. In this way, electrochemical device A1 was obtained.

### (Electrochemical Devices A2 to A7 and C1 to C7)

Electrochemical devices A2 to A7 and C1 to C7 were produced in the same manner as for electrochemical device A1 except that the average particle size of conductive polymer (P) and the average particle size and DBP absorption amount of conductive agent (C) were changed. The average particle sizes of conductive polymer (P) used in these electrochemical devices and the average particle size and DBP absorption amount of conductive agent (C) are shown in Table 1 below.

### (Evaluation of Electrochemical Device)

For the electrochemical devices prepared as described above, the capacity density and the direct current internal resistance were measured by the following method.

### (1) Method for Measuring Capacity Density

The capacity density was measured by the following method. First, the produced electrochemical device was charged to 3.6 V at 10 C. After maintaining at 3.6 V for 10 minutes, the electrochemical device was left for 1 minute and then discharged to 2.2 V at 10 C, and the discharge capacity was measured. Then, the capacity density was determined by dividing the measured discharge capacity by the mass of conductive polymer (P) in the positive electrode.

### (2) Method for Measuring Direct Current Internal Resistance

The direct current internal resistance was measured by the following method. First, the produced electrochemical device was charged at 3.6 V and 10 C (C represents the C-rate) for 10 minutes. After charging, the electrochemical device was left for 1 minute and then discharged at 10 C. The voltage between the terminals of the electrochemical device in the section from 0.05 seconds to 0.2 seconds after the start of discharging was measured to determine the amount of voltage drop. Then, the direct current internal resistance of the electrochemical device was calculated from the relationship between the amount of voltage drop and the discharge current.

Physical properties of materials used for producing the positive electrode of the electric device and evaluation results of the electric device are shown in Table 1. The average particle size ratio K/J shown in Table 1 is a value obtained by dividing an average particle size K of conductive polymer (P) by an average particle size J of conductive agent (C).

TABLE 1

| | Conductive | | | | | |
|---|---|---|---|---|---|---|
| | polymer (P) | Conductive agent (C) | | | Evaluation result | |
| | Average | Average | DBP | Average | | Direct current |
| | particle | particle | absorption | particle | Capacity | internal |
| Electrochemical | size K | size J | amount | size ratio | density | resistance |
| device | (μm) | (nm) | (ml/100 g) | K/J | (mAh/g) | (mΩ) |
| C1 | 1 | 45 | 130 | 22 | 42 | 125 |
| C2 | 3 | 1 | 170 | 3000 | 38 | 123 |
| A1 | 3 | 5 | 160 | 600 | 69 | 66 |
| A2 | 3 | 30 | 120 | 100 | 71 | 69 |
| C3 | 3 | 50 | 170 | 60 | 45 | 130 |
| C4 | 0.5 | 18 | 130 | 28 | 49 | 115 |
| A3 | 1 | 18 | 130 | 56 | 71 | 72 |
| A4 | 3 | 18 | 130 | 167 | 79 | 60 |
| A5 | 5 | 18 | 130 | 278 | 73 | 75 |
| C5 | 20 | 18 | 130 | 1111 | 46 | 112 |
| C6 | 3 | 30 | 90 | 100 | 35 | 103 |
| A6 | 3 | 22 | 150 | 136 | 65 | 76 |
| A7 | 3 | 25 | 110 | 120 | 63 | 78 |
| C7 | 3 | 25 | 480 | 120 | 0.1 | 2380 |

As shown in Table 1, when (1) the average particle size of conductive polymer (P) was in the range from 1 μm to 5 μm, inclusive, (2) the average particle size of conductive agent (C) was in the range from 5 nm to 30 nm, inclusive, and (3) the DBP absorption amount of conductive agent (C) was in the range from 110 ml/100 g to 160 ml/100 g, inclusive, a high-capacitance and low-resistance electrochemical device was obtained.

In comparison between electrochemical devices A1 and A2 and electrochemical device C2, when the average particle size of conductive agent (C) was too small, the resistance increased, and the capacity density decreased. In comparison between electrochemical devices A6 and A7 and electrochemical device C7, when the DBP absorption amount of conductive agent (C) was too large, the resistance increased, and the capacity density decreased. These results are considered to be because when the average particle size of conductive agent (C) is too small or when the DBP absorption amount is too large, particles of conductive agents (C) are likely to aggregate.

When the particles of the conductive polymer (conductive polymer (P)) are used as a material involved in charging and discharging, it is considered important that conductive agent (C) surrounds and covers conductive polymer (P) as uniformly as possible. For this purpose, it is necessary to suppress aggregation of conductive agent (C) and to increase the proportion of conductive agent (C) present on the surface of conductive polymer (P). It is considered that the proportion of conductive agent (C) present on the surface of conductive polymer (P) can be increased by satisfying conditions (1) to (3) above.

From the above results, it is considered that in electrochemical devices A1 to A7, the cohesive force between the particles of the active material (conductive polymer (P)) and conductive agent (C) is greater than the cohesive force between conductive agent (C). On the other hand, it is considered that in electrochemical devices C1 to C7, the cohesive force between the particles of the active material (conductive polymer (P)) and conductive agent (C) is smaller than the cohesive force between conductive agent (C).

### INDUSTRIAL APPLICABILITY

The present disclosure can be applied to a power storage device.

### REFERENCE MARKS IN THE DRAWINGS

10 positive electrode
20 negative electrode
200 electrochemical device

1. An electrochemical device comprising:
a positive electrode; and
a negative electrode,
wherein:
the positive electrode includes a positive electrode material layer,
the positive electrode material layer includes particles of a conductive polymer as an active material and particles of a conductive agent, and
an average particle size the particles of the conductive polymer is in the range from 1 μm to 5 μm, inclusive.

2. The electrochemical device according to claim 1, wherein the particles of the conductive agent are disposed on surfaces of the particles of the conductive polymer.

3. The electrochemical device according to claim 1, wherein a cohesive force between the particles of the active material and the particles of the conductive agent is greater than a cohesive force between the particles of the conductive agent.

4. The electrochemical device according to claim 1, wherein an average particle size of the particles of the conductive agent is in the range from 5 nm to 30 nm, inclusive.

5. The electrochemical device according to claim 1, wherein a DBP absorption amount of the particles of the conductive agent is in the range from 110 ml/100 g to 160 ml/100 g, inclusive.

6. The electrochemical device according to claim 1, wherein the particles of the conductive polymer includes polyaniline.
